(19) United States
(12) Patent Application Publication
(10) Pub. No.: US 2016/0297917 A1
(43) Pub. Date: Oct. 13, 2016

(54) REACTION SYSTEM FOR A LOW-MONOMER CONTENT SINGLE-COMPONENT POLYURETHANE FOAM II

(71) Applicant: Covestro Deutschland AG, Leverkusen (DE)

(72) Inventors: Erhard MICHELS, Stade (DE); Reinhard ALBERS, Leverkusen (DE); Stephanie VOGEL, Langenfeld (DE)

(21) Appl. No.: 15/100,853

(22) PCT Filed: Dec. 2, 2014
(86) PCT No.: PCT/EP2014/076234

§ 371 Date: Jun. 1, 2016

(30) Foreign Application Priority Data
Dec. 4, 2013 (EP) 13195652.6

(51) Int. Cl. C08G 18/10; C08G 18/08; C08J 9/00; C08G 18/48; C08G 18/42; C08J 9/14; C08G 18/20; C08G 18/34

(52) U.S. Cl. CPC C08G 18/10; C08G 18/2018; C08G 18/14; C08G 18/341; C08G 18/4833; C08G 18/48; C08G 18/4216; C08J 9/141; C08J 9/0061; C08J 2203/14; C08J 2205/10; C08G 2101/0025

(57) ABSTRACT

Lubricant composition comprising a dicarboxylic acid ester component which is selected from di-isononyladipate and di-(2-ethylhexyl) adipate, and ethylene-propylene copolymer, and a monocarboxylic acids ester.

The present invention relates to a one component reaction system for production of rigid polyurethane foams that comprises the following constituents:
A) an organic polyisocyanate component partially or completely in the form of a prepolymer,
B) an isocyanate-reactive component whose functional groups are exclusively those having at least one Zerewitinoff-reactive hydrogen atom and also, optionally, at least one halogen atom,
C) at least one stabilizer,
D) at least one catalyst suitable for catalyzing the reaction of said polyisocyanate component A) with said isocyanate-reactive component B), and also
B) optionally auxiliary and added-substance materials and also blowing agent and co-blowing agent:

The invention further relates to a method of preparing a one component reaction system, to a method of producing rigid polyurethane foams from a one component reaction system, to a rigid foam obtainable from a one component reaction system, to the method of using a one component reaction system as a 1-K assembly foam, and also to a pressurized container containing a reaction system and a propellant.

The production of polyurethane foams from disposable pressurized containers is known. It involves a prepolymer comprising isocyanate groups being prepared by reaction of polyols with organic di- and/or polyisocyanates in the presence of foam stabilizers and catalysts and optionally also of plasticizers, flame retardants, crosslinkers and further added-substance materials. This reaction normally takes place in the presence of liquefied propellant gas in a pressurized container. On completion of prepolymer formation, the foam is then dispensable via a valve in metered fashion. The foam in question first has a creamy consistence before subsequently hardening/curing by agency of ambient moisture, from the air for example, with an increase in volume. Foams of this type are therefore known as one component foams (1K foams).

Properties desired in the final foam, e.g., rigidity and cellurality, are secured to it by employing the isocyanate in a distinct excess over the polyol components. This serves to control the so-called advancement and hence the molecular weight distribution of the prepolymer. The lower the advancement, the narrower the molecular weight distribution, the greater the precision to which the final properties are securable to the cured PU foam. However, a consequence of this procedure is that, following completion of prepolymer formation, the pressurized container will still be containing a lot of free, unconverted MDI, on the order of about 7 to 15 wt % based on the total pressurized container contents. Monomeric MDI comprises a large proportion of this free MDI. Owing to this high level of free monomeric MDI, compositions of this type are required under EU law to be labeled with R40 and “harmful, contains 4,4′-biphenylene diisocyanate” and the hazard symbol Xn. Germany additionally has stricter legislation in the form of the so-called Self-Service Ban (section 4 of the German Regulation Banning Certain Chemicals), banning the sale in Germany of R40-labeled products on the open market directly to the consumer. Therefore, such 1K PU foam cans are kept locked away in glass cabinets in German home improver stores, and may only be sold to the consumer by trained personnel (section 5 of the German Regulation Banning Certain Chemicals). France, Austria and Slovenia have similar legislation.

EP 0 746 580 B1 discloses a composition for production of 1-K polyurethane foams from disposable pressurized containers wherein the residue remaining in the pressurized container has a diisocyanate monomer content of less than 5.0 wt % one day after use at the latest, while the isocyanate prepolymer has an isocyanate content of 8 to 30 wt %.

DE 10 2009 045 027 A1 describes a crosslinkable foamable composition having a low monomeric isocyanate content. Said composition comprises a) 10 to 90 wt % of a prepolymer formed from polyester diols reacted with an excess of diisocyanates and subsequent removal of excess monomeric diisocyanate, b) 10 to 90 wt % of a component based on polyether polyols which contains either at least one (Si(OR)₃ group or at least one NCO group, c) 0.1 to 30 wt % of additives, d) and at least one blowing agent, wherein the polyester diols and the polyether diols have a molar mass (M_{N}) below 5000 g/mol and the mixture of a and b has a monomeric diisocyanate content below 1 wt %.

One of the characteristics of the aforementioned compositions is that appreciable amounts of flame retardant additives have to be added to establish desirable fire/flame protection properties. However, the use of high concentrations of liquid flame retardants is disadvantageous, since flame retardants not incorporable into the polyurethane scaffold act as plasticizers and adversely affect foam rigidity.

The problem addressed by the present invention is that of providing a low monomer 1K PU formulation based on a corresponding prepolymer, and combining high mechanical strength for a resultant foam with good tire behavior.

The problem is solved by a one component reaction system for production of rigid polyurethane foams that comprises the following constituents:
A) an organic polyisocyanate component partially or completely in the form of a prepolymer,
B) an isocyanate-reactive component whose functional groups are exclusively those having at least one Zerewitinoff-reactive hydrogen atom and also, optionally, at least one halogen atom,
C) at least one stabilizer,
D) at least one catalyst suitable for catalyzing the reaction of said polyisocyanate component A) with said isocyanate-reactive component B), and also
E) optionally auxiliary and added-substance materials and also blowing agent and co-blowing agent,

wherein the reaction system is characterized in that said stabilizer C) is selected from the group of polyether-polydialkoxysilane copolymers.

Surprisingly, tire classes E (flame height≦150 mm) and F (flame height>150 mm) were found to be achievable with one and the same formulation by employing the stabilizer of the present invention. Only very minimal if any admixtures of flame retardant may be used. This observation is surprising in particular because it is state of the art either to employ very high amounts of flame retardants or alternatively to switch to polyol components comprising polyester polyols. The use of high concentrations of liquid flame retardants, however, is disadvantageous, since flame retardants not incorporable into the polyurethane scaffold are deemed to be, as noted, plasticizers and thus have a severely adverse effect on foam rigidity. But this must be avoided at all costs, since the use of prepolymers in the manner of the present invention and the avoidance of free monomeric MDI will cause the final rigidity of such a 1K PU foam to be in any case lower than that of those produced conventionally on the basis of polymeric MDI. The reason for this is the distinctly reduced proportion of monomeric MDI, which leads to a correspondingly high rigidity and hard segment content. The trick is therefore not just to produce a technically convincing rigid PU foam having reasonable final rigidities on the basis of a prepolymer but also to additionally render this foam flame resistant. The use of polyester polyols for this purpose is not absolutely desirable for the purposes of the present invention, since the viscosities of low monomer polyester polyol prepolymers are already exorbitantly high, so a prepolymer based thereon will be but very difficult to process industrially. Hence the reaction system of the present invention and/or its polyol component B) in this embodiment is preferably free from polyester polyols or prepolymers based thereon.

The same as explained hereinabove and also hereinbelow with reference to MDI as isocyanate also holds for other isocyanates, for example TDI.

In a prefefered implementation of the reaction system of the present invention, the monomeric polyisocyanate content is not more than 1 wt %. The organic polyisocyanate component A) preferably has an isocyanate content of less than 15 wt % based on said polyisocyanate component A), in particular of less than 12 wt %.

Surprisingly, despite the low level of monomeric polyisocyanate and the attendant higher molecular weight for the prepolymer of the organic polyisocyanate component, the reaction system of the present invention was found to be still miscible, and dispensable from disposable pressurized containers, with the other constituents of the reaction mixture to deliver foams of satisfactory rigidity.

The abovementioned preferred embodiment provides that the reaction system has a monomeric polyisocyanate content of not more than 1 wt %. The monomeric isocyanate content can thus also be less than 0.1%. This for the purposes of the present invention is to be understood as meaning that this content is not exceeded directly after mixing the individual components of the reaction system. Hence the monomeric polyisocyanate content may if anything decrease over a period of several days,

The organic polyisocyanate component A) of the reaction system according to the present invention may combine a functionality of 2.5 with an average molecular weight of 700 g/mol to 5000 g/mol, in particular 800 g/mol to 2500 g/mol.

The organic polyisocyanate component A) employed in the reaction system of the present invention may in principle be formed in any conventional manner. In advantageous embodiments, the organic polyisocyanate component A) is prepared by reaction of at least one isocyanate-reactive compound with an excess of at least one monomeric organic polyisocyanate compound followed by distillative removal of unreacted monomeric organic polyisocyanate compound, wherein the isocyanate-reactive compound is more particularly selected from polyether polyols, polyester polyols and/or polyetherester polyols, preferably from a polyol comprising propylene oxide units,

Preferably, said organic polyisocyanate component A) comprises no catalytic component catalyzing the prepolymerization (“prepolymerization catalyst”) or at most technically unavoidable traces of a prepolymerization catalyst.

The organic polyisocyanate component A) may have an isocyanate content of 2 to 15 wt % based on the polyisocyanate component A), in particular 3 to 13.5 wt %.

The organic polyisocyanate component A) may further have a viscosity of 2000 mPa s to 70 000 mPa s measured at 50° C. to DIN 53019, in particular 5000 mPa s to 50 000 MPa s. This is particularly advantageous because such polyisocyanate components A) are still efficiently foamable while at the same time making compliance with the low residual monomer content of the invention possible.

As mentioned above, corresponding fire properties are achievable without (significant) further admixture of flame retardants. This is surprising in particular because the person of ordinary skill in the art knows that normal PU rigid foams need very high admixtures (20-50 wt % based on the polyol formulation) of flame retardants to meet these fire requirements. By contrast, PUR-PIR rigid foams need lower admixtures of flame retardant at for instance <20 wt % based on the polyol formulation by virtue of the inherently more flame-resistant properties of the trimerized polymer.

Surprisingly, there has now been found a formulation that needs very little if any flame retardant in order to meet the fire requirements for fire class E. Hence a particularly preferred embodiment of the reaction system according to the present invention comprises less than 5 wt % of a flame retardant selected from the group of compounds consisting of halogenated phosphates, aryl phosphates, alkyl phosphates, alkyl aryl phosphates, phosphonates and also flame retardants without groups reactive toward polyisocyanates and/or polyols. The reaction system preferably contains less than 2 wt %, more preferably less than 1 wt % and yet more preferably no flame retardant selected from this group. This is advantageous because using such flame retardants could, via the plasticizing effect of these flame retardants, reduce the rigidity of the foam produced from the reaction system, which is generally undesirable.

It is further preferable for the isocyanate-reactive component B) to contain at least one polyol or to consist of one or more polyols, wherein the polyol more particularly has
an OH number of 100 to 400 mg KOH/g, preferably 150 to 300, and/or
an OH functionality of 1 to 4, preferably 1.5 to 3.5, more preferably 1.9 to 3.0.

Employing these polyols is preferable because the foams resulting from their use have an EN ISO 11925-2 flame height of ≦150 mm, which corresponds to fire class E under DIN EN 13501-1. It is thus possible for instance to comply with said fire class without using an additional flame retardant without groups reactive toward polyisocyanates and/or polyols, which would be disadvantageous for the rigidity of the foam owing to the plasticizing properties. Particularly preferred polyols are selected from polyether polyols, polyester polyols and/or polyetherester polyols, more preferably from a polyol comprising ethylene oxide units, most preferably from a polyethylene polyol.

In a further embodiment of the reaction system according to the invention, stabilizer C) is selected from the group of polyether-polydialkoxysilane copolymers, wherein the alkoxy groups are each selected independently from aliphatic hydrocarbyl moieties having one to ten carbon atoms, preferably from methyl, ethyl, n-propyl or i-propyl.

The stabilizer C) may have a cloud point of not less than 40° C., in particular of not less than 50° C., preferably of not less than 60° C., measured in a 4 wt % aqueous solution of the stabilizer and incrementally raising the temperature from 20° C. starting at a heating rate of 2° C./min and ascertaining the cloud point by visually judging the onset of clouding. This is advantageous because the fire protection properties of the rigid polyurethane foams obtained are further enhanceable by employing such stabilizers. The aforementioned values of the cloud point may alternatively also be determined nephelometrically by enlisting DIN-EN-ISO 7027 without being tied to the aforementioned procedure involving a combined change in the temperature.

Catalyst D) of the reaction system according to the present invention may in principle be any catalyst known to a person skilled in the art as suitable for this purpose, for example an amine catalyst.

In a preferred further development of the reaction system according to the present invention, the monomeric polyisocyanate content is less than 1 wt %, in particular less than 0.9 wt %, preferably 0.1 wt % or less.

The reaction system further comprises an acid having a pKa value of not less than 0, in particular in an amount of 10 to 500 ppm based on the amount of organic polyisocyanate component A), preferably in an amount of 50 to 300 ppm. The admixture of such compounds may be used to very substantially prevent any reaction of the prepolymer with itself, for example an allophanatization.

A preferred reaction system of the present invention contains or consists of the following components:
70 to 90 wt % of one organic polyisocyanate component A),
0.5 to 5 wt % of isocyanate-reactive component B),
0.1 to 1.0 wt % of stabilizer C), selected from the group of polyether-polydialkoxysilane copolymers,
0.1 to 1.0 wt % of catalyst D), and/or
9 to 25 wt % of auxiliary and added-substance materials and also blowing agent and co-blowing agent,
all based on the reaction system.

The present invention further provides a method of preparing a one component reaction system of the present invention, wherein
A) an organic polyisocyanate component partially or completely in the form of a prepolymer,
B) an isocyanate-reactive component whose functional groups are exclusively those having at least one Zerewitinoff-reactive hydrogen atom and also, optionally, at least one halogen atom,
C) at least one stabilizer,
D) at least one catalyst suitable for catalyzing the reaction of said polyisocyanate component A) with said isocyanate-reactive component B), and also
E) optionally auxiliary and added-substance materials and also blowing agent and co-blowing agent,
are mixed with one another,

wherein the method is characterized in that said stabilizer C) is selected from the group of polyether-polydialkoxysilane copolymers.

The invention further provides a method of producing rigid PU foams, which comprises said components A) to E) of a reaction system according to the present invention being mixed and more particularly reacted with one another under agency of moisture.

The present invention further provides a rigid foam obtainable by mixing and reacting said components A) to E) of a reaction system according to the present invention.

The invention is also directed to the method of using a reaction system according to the present invention as a 1-K assembly foam, wherein the reaction system and a propellant and optionally also a co-propellant are more particularly contained in a pressurized container such as a disposable pressurized container.

The invention lastly also provides a pressurized container, in particular a disposable pressurized container, containing a reaction system according to the present invention and a propellant and optionally also a co-propellant.

The present invention will now be more particularly described with reference to working examples.

Experimental Part

The rigid PU foams of the present invention are produced by a conventional two-step process wherein the reaction components are batchwise reacted with one another and then transported into/onto suitable molds/substrates/cavities for curing. Examples are described in U.S. Pat. No. 2,761,565, in G. Oertel (ed.) “Kunststoff-Handbuch”, volume VII, Carl Hanser Verlag, 3rd edition, Munich 1993, pp. 284 ff., and also in K. Uhlig (ed.) “Polyurethan Taschenbuch”, Carl Hanser Verlag, 2nd edition, Vienna 2001, pp. 83-102.

In the case of the present application, 1-component (1K) recipes consisting of a prepolymer formulation comprising a propellant gas (see table 1) and additives were prepared in a pressurized can. To this end, an NCO-terminated prepolymer, an NCO-reactive component and additives (e.g., catalysts, foam stabilizers) were weighed in succession into a pressurizable can and the can was tightly sealed. This can was subsequently pressurized with propellant gas and the mixture homogenized by shaking. Dispensation of foam was effected after storing the can for one day under standard conditions (room temperature, 1013 mbar), after the respective substrate had been precisely moistened with water. Curing the molded and/or free rise foam likewise took place at the currently prevailing air pressures and humidities at room temperature.

The following materials were used:
polyol 1: polyether polyol having an OH number of 235 mg KOH/g, a theoretical functionality of 3.0 and a viscosity of 250 mPas at 25° C., prepared by reacting a trifunctional starter mixture with propylenene oxide (Bayer MaterialScience),
polyol 2: polyether polyol having an OH number of 112 mg KOH/g, a theoretical functionality of 2.0 and a viscosity of 140 mPas 25° C., prepared by reacting a difunctional starter mixture with propylenene oxide (Bayer MaterialScience);
polyol 3: PHT4-DIOL (2-(2-hydroxyethoxy)ethyl 2-hydroxypropyl 3,4,5,6-tetrabromo-phthalate), (Chemtura);

polyol 4: polyether polyol having an OH number of 190 mg KOH/g, a theoretical functionality of 2.0 and a viscosity of 122 mPas at 25° C., prepared by reacting a difunctional starter mixture with ethylene oxide (Bayer MaterialScience);
polyol 5: polyether polyol having an OH number of 255 mg KOH/g, a theoretical functionality of 3.0 and a viscosity of 265 mPas at 25° C., prepared by reacting a trifunctional starter mixture with ethylene oxide (Bayer MaterialScience);
polyol 6: polyether polyol having an OH number of 232 mg KOH/g, a theoretical functionality of 3.0 and a viscosity of 350 mPas at 25° C., prepared by reacting a trifunctional starter mixture with propylene oxide (Bayer MaterialScience);
polyol 7: polyether polyol having an OH number of 260 mg KOH/g, a theoretical functionality of 2.0 and a viscosity of 70 mPas at 25° C., prepared by reacting a difunctional starter mixture with propylene oxide (Bayer MaterialScience):
polyol 8: polyester polyol having an OH number of 240 mg KOH/g, a theoretical functionality of 2.0 and a viscosity of 15 600 mPas at 20° C. prepared by the condensation of phthalic acid and adipic acid with diethylene glycol (Bayer MaterialScience);
isocyanate 1: monomeric aromatic diisocyanate based on 4,4′-diphenylmethane diisocyanate (about 40 wt %) and 2,4-diphenylmethane diisocyanate (about 60 wt %), (Bayer MaterialScience);
prepolymer 1: NCO-terminated prepolymer of functionality f=2.5, residual NCO content 6.5%, viscosity 22 000 mPa s at 50° C. and residual free monomeric MDI content about 0.65%, obtained by the reaction of polyol 1 and polyol 2 with isocyanate 1 and subsequent distillation;
prepolymer 2: NCO-terminated prepolymer of functionality f=2.5, residual NCO content 6.9%, viscosity 15 000 mPa s at 50° C. and residual free monomeric MDI content about 0.90%, obtained by the reaction of polyol 1 and polyol 2 with isocyanate 1 and subsequent distillation;
stabilizers: Tegostab® (Evonik);
stabilizer A1: Tegostab B8421 polyether-polydimethyisiloxane copolymer
stabilizer A2; Tegostab B8461 polyether-polydimethylsiloxane copolymer
stabilizer B1: Tegostab B8870 polyether-polydimethylsiloxane copolymer
stabilizer B2: Tegostab B8871 polyether-polydimethylsiloxane copolymer
amine catalyst: DMDEE (2,2′-dimorpholinodiethyl ether), (AirProducts)
isobutane: (Gerling Holz+Co)
DME: dimethyl ether (Gerling Holz+Co)

Definition of Cloud Point for Stabilizers:

The foam stabilizers employed in this application are all members of the class of polyether-polydimethylsiloxane copolymers. While their construction and method of making are not fundamentally different, their respective modes of action do exhibit differences and can be explained via their chemical compositions. Foam stabilizers are therefore subdividable into classes such as, for example, hydrophilic or hydrophobic and siloxane lean or siloxane rich. Macroscopically, such a classification is possible via the particular cloud point of a foam stabilizer. The cloud point of a foam stabilizer is thus an indication of quality, but at the same time it is greatly dependent on the method used to determine it. The degree of turbidity, or the clear point, can be determined nephelometrically by enlisting DIN-EN-ISO 7027, although it does not describe a procedure involving a combined change in the temperature. A purely visual method of determination has accordingly proved advantageous in practice because, in view of the temperature interval to be traversed, it has proved to be quick to carry out and sufficiently informative. The cloud points reported in the present application were thus measured as follows: A 4% aqueous solutions of a corresponding polyether-polydimethylsiloxane copolymer was gradually heated up stepwise under constant agitation. The temperature at which clouding of the uniformly hot solution ensued defined the particular cloud point. By this measure, relatively hydrophilic foam stabilizers tend to have higher cloud points than relatively hydrophobic foam stabilizers. The cloud points thus determined for the foam stabilizers employed in this application are summarized in table 1.

TABLE 1
Characteristics of foam stabilizers employed.

| Stabilizer | Cloud point [° C.] | Quality feature |
|---|---|---|
| Stabilizer A1 | 66 | hydrophilic |
| Stabilizer A2 | 64 | hydrophilic |
| Stabilizer B1 | 35 | hydrophobic |
| Stabilizer B2 | <23 | hydrophobic |

Prepolymer Synthesis:

The standard method of prepolymer synthesis is known to the person having ordinary skill in the art and therefore will not be detailed in what follows. Briefly: isocyanate 1 was reacted in a stoichiometric excess with polyol 1 and polyol 2 in a conventional manner in a first stage to form the respective crude prepolymers. To prepare the low monomer isocyanate prepolymers 1 and 2, these crude prepolymers were distilled in thin film or short path evaporators at temperatures of 100 to 200° C. under reduced pressure to remove the volatile monomeric isocyanate 1 used in excess, until the desired residual monomer content was attained. The properties of prepolymers 1 and 2 thus obtained are summarized in table 2:

TABLE 2
Product properties of prepolymers 1 and 2.

| Property | Dimension | Prepolymer 1 | Prepolymer 2 |
|---|---|---|---|
| Functionality | — | 2.5 | 2.5 |
| Residual NCO content | % | 6.5 | 6.9 |
| Viscosity (50° C.) | mPa s | 22 000 | 15 000 |
| Free, monomeric MDI* | wt % | 0.65 | 0.90 |

*determined by a validated HPLC method of the external testing institute CURRENTA GmbH & Co. Ohg.

Preparation of 1K Formulations in Disposable Pressurized Containers:

Prepolymers 1 and 2 were used to prepare 1K formulations in disposable pressurized containers in a manner known to a person of ordinary skill in the art. To this end, the required amounts of the particular prepolymer 1 or 2 were initially charged in succession to the open container. Thereafter, the corresponding amounts of stabilizer, of amine catalyst and of a further polyol were weighed out and added and the disposable container tightly sealed. The required amounts of the propellant gases were then admixed via the installed valve using a corresponding metering unit. Finally, the disposable pressurized container was shaken to completely homogenize the 1K formulation. The 1K formulations thus obtained are hereinbelow reported in the examples of table 3. These formulations and their ratios as reported here are freely conformable to the desired fill volumes of various disposable pressurized containers. Unless otherwise stated, 750 mL of each of the 1K formulations itemized in table 3 were filled into disposable pressurized containers having a capacity of 1000 mL.

Production of Free Rise Foams:

Following a period of storage for the disposable pressurized container filled with the 1K formulation, dispensation was effected onto a water-sprayed layer of paper (PE-coated soda kraft paper, 130 g/m², 595×160 mm). For this, the pressurized container was guided upside down over the paper in a long, line-drawing movement without interruption. The foam expanded under the currently prevailing conditions (room temperature, atmospheric pressure). The moisture required for curing was supplied by spraying the paper with water. This procedure delivered the most reproducible results, since it was thus independent of the particular humidities prevailing.

Measurement of Tack-Free Time:

After dispensing, the foam surface was tested for tackiness with a wooden spatula at defined intervals. To this end, the wooden spatula was lightly placed on the foam surface and lifted off again. The time at which threads are no longer being pulled or detachment of material was no longer observed at the foam surface defines the tack-free time.

Assessment of Foam Structure, Cell Size and Rigidity:

These three criteria were subjectively assessed on the free rise foam generally one day after its dispensing. To this end, the employee, who was experienced in this methodology, was presented with corresponding comparative samples versus which the assessment was done in accordance with a German school grading system. The numbers reported for this therefore have the following meaning: 1=very good, 2=good, 3=fair, 4=satisfactory, 5=unsatisfactory, 6=not even unsatisfactory.

Production of Test Specimens for Measuring the Fire Properties:

The fire properties were established on foamed moldings. To this end, a shaft (700×90×55 mm) lined lengthwise with plasterboard panels (700×90×12.5 mm) at right and left and open at the top was foamed out using a single, uninterrupted dispensing movement. The foam front protruding across the top over the length of 700 mm was separated off such that the foam layer was flush with the plasterboard panels. This accordingly produced sandwich elements 700 mm in length and 90 mm in height which, distributed across the thickness, had the following layered construction: plasterboard (12.5 mm), PU foam (30 mm), plasterboard (12.5 mm). These elements were cut down to 190 mm and subjected to a fire test. This was done by performing a small burner test as per DIN 4102-1 (edge flaming).

All the results regarding the rigid PU foams obtained according to the present application and their properties are summarized in table 4.

TABLE 3
Composition of 1K formulations. The stated values are parts by weight.

| Example | 1 | 2 | 3 | 4 | 5 | 6 | 7 | 8 | 9 | 10 | 11 | 12 | 13 |
|---|---|---|---|---|---|---|---|---|---|---|---|---|---|
| polyol 3 | 5.0 | 5.0 | | | | | 5.0 | | | 5.0 | 5.0 | | |
| polyol 4 | | | | 5.0 | | 5.0 | | | | | | 5.0 | |
| polyol 5 | | | 5.0 | | | | | | | | | | 5.0 |
| polyol 6 | | | | | | | | 5.0 | | | | | |
| polyol 7 | | | | | | | | | 5.0 | | | | |
| polyol 8 | | | | | 5.0 | | | | | | | | |
| stabilizer A1 | | 1.1 | 1.1 | 1.1 | 1.1 | 1.1 | 1.1 | 1.1 | 1.1 | | | | |
| stabilizer A2 | 1.1 | | | | | | | | | | | | |
| stabilizer B1 | | | | | | | | | | | 1.1 | | |
| stabilizer B2 | | | | | | | | | | 1.1 | | 1.1 | 1.1 |
| amine catalyst | 1.4 | 1.4 | 1.4 | 1.4 | 1.4 | 1.4 | 1.4 | 1.4 | 1.4 | 1.4 | 1.4 | 1.4 | 1.4 |
| prepolymer 1 | 353 | 353 | 353 | 353 | 353 | | | 353 | 353 | 353 | 353 | 353 | 353 |
| prepolymer 2 | | | | | | 353 | 353 | | | | | | |
| isobutane | 57.8 | 57.8 | 57.8 | 57.8 | 57.8 | 57.8 | 57.8 | 57.8 | 57.8 | 57.8 | 57.8 | 57.8 | 57.8 |
| dimethyl ether | 35.8 | 35.8 | 35.8 | 35.8 | 35.8 | 35.8 | 35.8 | 35.8 | 35.8 | 35.8 | 35.8 | 35.8 | 35.8 |

TABLE 4
Summary of foam properties measured.

| Example | | 1 | 2 | 3 | 4 | 5 | 6 | 7 | 8 | 9 | 10 | 11 | 12 | 13 |
|---|---|---|---|---|---|---|---|---|---|---|---|---|---|---|
| tack-free time | min | 13 | 12 | 11 | 13 | 10 | 18 | 17 | 12 | 14 | 12 | 22 | 22 | 18 |
| foam structure^{a} | — | 1 | 1 | 1 | 1 | 1 | 1 | 1 | 1 | 1 | 1 | 1 | 1 | 1 |
| cell size^{a} | — | 3 | 2 | 2 | 2 | 3 | 1 | 2 | 1 | 2 | 3 | 3 | 4 | 3 |
| rigidity^{a} | — | 1 | 2 | 2 | 2 | 2 | 2 | 2 | 2 | 3 | 1 | 1 | 2 | 2 |
| flame height | mm | 138 | 107 | 103 | 100 | 83 | 110 | 70 | 200 | 173 | 300 | 300 | 167 | 153 |
| fire class^{b} | — | B2 | B2 | B2 | B2 | B2 | B2 | B2 | B3 | B3 | B3 | B3 | B3 | B3 |
| free MDI monomer in | % | 0.65 | 0.65 | 0.65 | 0.65 | 0.65 | 0.90 | 0.90 | 0.65 | 0.65 | 0.65 | 0.65 | 0.65 | 0.65 |
| prepolymer | | | | | | | | | | | | | | |
| free MDI monomer in | % | 0.51 | 0.51 | 0.51 | 0.51 | 0.51 | 0.70 | 0.70 | 0.51 | 0.51 | 0.51 | 0.51 | 0.51 | 0.51 |
| pressurized container | | | | | | | | | | | | | | |

^{a}subjective assessment corresponds to German school grades where 1 = very good, 2 0 good, 3 = fair, 4 = satisfactory, 5 = unsatisfactory, 6 = not even unsatisfactory;
^{b}as per DIN 4102-1.

Examples 1 to 5 and 8 to 13 were all carried out with prepolymer 1. The concentrations for the propellant gases, the prepolymer, the catalyst, the stabilizer and the polyol used were the same in every case. The examples only ever differ in one respect. Either the polyol or the stabilizer was varied. Despite this minimal variation, Examples 1 to 5 all exhibited a B2 fire behavior, whereas Examples 8 to 13 all exhibited a B3 fire behavior. Specifically, comparing Examples 1 and 2 with Examples 10 and 11, it is noticeable that using the same polyol and simply exchanging the stabilizer results in a completely different outcome for the fire behavior. Stabilizers A1 and A2 were employed in Examples 1 and 2. Both must be categorized as hydrophilic and have a relatively high cloud point (cf. table 1). In contradistinction thereto, stabilizers B1 and B2 are hydrophobic and have relatively low cloud points (cf. table 1). This trend in fire behavior according to the choice of stabilizer is all the more distinct considering it was found not just in a direct comparison between individual stabilizers. Examples 1 and 2 show this trend for two different stabilizers that are members of the same category (cf. table 1). By comparison, the foams produced in Examples 10 and 11 likewise display a very similar fire behavior to each other, yet completely at odds with that of the foams from Examples 1 and 2, which employed stabilizers A1 and A2. Simply exchanging a stabilizer while keeping the composition otherwise the same therefore led, surprisingly, to a completely different fire behavior.

In addition to the stabilizer, however, the very low, 1% admixture of the polyol apparently also had a considerable influence on the macroscopic fire behavior of a foam produced therefrom. On comparing Examples 1 to 5 with each other, it becomes clear that employing the incorporable brominated flame retardant (polyol 3), the two EO-containing polyols 4 and 5 and the polyester polyol (polyol 8) always resulted in a B2 fire behavior on using a stabilizer of the A type. In a direct comparison therewith. Examples 8 and 9 unambiguously resulted in a B3 fire behavior, even though a stabilizer of the A type had been used. The reason appears to reside in the polyols used. The polyether polyols used in both cases had side chains constructed exclusively from propylene oxide. However, the polyether polyol alone does not define the likely fire behavior. This is because comparing Examples 3 and 4 with Examples 12 and 13 reveals that EO-containing polyols were used in all four cases but that in Examples 12 and 13 they were combined with stabilizers of the B type, the final outcome of which is a B3 behavior.

The surprising finding is therefore in summary that the combination of EO-containing polyols or polyester polyols or brominated incorporable flame retardants with an A type stabilizer in the tested 1K formulation of the present application led to a B2 fire behavior. This combination is accordingly particularly preferable for production of PU foams to be, for example, processed as an assembly foam in the building construction sector in Germany, since for this use the legislator has mandated a B2 fire behavior for the materials used. However, the fire behavior changes dramatically on exchanging just one component. For instance, the choice of a B type stabilizer in an otherwise unchanged formulation will turn a B2 formulation (cf. Examples 1 to 5) into a B3 formulation (cf. Examples 10 to 13). On the other hand, the choice of an A type stabilizer is not a basic prerequisite to obtain a B2 formulation. This is because the combination of an A type stabilizer delivered a B3 formulation in Examples 8 and 9, since polyether polyols having exclusively propoxylated side chains were combined in the formulation in these cases.

The present invention is not limited to a single prepolymer. Prepolymer 2 was employed in Examples 6 and 7 to prepare the 1K formulation. The resulting tire behavior is directly comparable to that of the formulations from Examples 4 and 2. This Observation confirms the general applicability of the present invention.

1.-17. (Canceled)

18. A one component reaction system for production of rigid polyurethane foams comprising
A) an organic polyisocyanate component partially or completely in the form of a prepolymer,
B) an isocyanate-reactive component whose functional groups are exclusively those having at least one Zerewitinoff-reactive hydrogen atom and also, optionally, at least one halogen atom,
C) at least one stabilizer,
D) at least one catalyst suitable for catalyzing the reaction of said polyisocyanate component A) with said isocyanate-reactive component B), and also
E) optionally auxiliary and added-substance materials and also blowing agent and co-blowing agent,
wherein
the stabilizer C) is selected from the group of polyether-polydialkoxysilane copolymers.

19. The one component reaction system as claimed in claim 18, wherein the monomeric polyisocyanate content is not more than 1 wt %, and wherein the organic polyisocyanate component A) has an isocyanate content of less than 15 wt % based on said polyisocyanate component A).

20. The one component reaction system as claimed in claim 18, wherein said organic polyisocyanate component A) combines a functionality of 2.5 with an average molecular weight of 700 g/mol to 5000 g/mol.

21. The one component reaction system as claimed in claim 18, wherein said organic polyisocyanate component A) is prepared by reaction of at least one isocyanate-reactive compound with an excess of at least one monomeric organic polyisocyanate compound followed by distillative removal of unreacted monomeric organic polyisocyanate compound, and wherein the isocyanate-reactive compound is selected from polyether polyols, polyester polyols and/or polyetherester polyols.

22. The one component reaction system as claimed in claim 18, wherein said organic polyisocyanate component A) has an isocyanate content of 2 to 15 wt % based on said polyisocyanate component A).

23. The one component reaction system as claimed in claim 18, wherein said organic polyisocyanate component A) comprises no prepolymerization catalyst or at most technically unavoidable traces of a prepolymerization catalyst.

24. The one component reaction system as claimed in claim 18, wherein the one component reaction system comprises less than 5 wt % of a flame retardant selected from the group of compounds consisting of halogenated phosphates, aryl phosphates, alkyl phosphates, alkyl aryl phosphates, phosphonates and also flame retardants without groups reactive toward polyisocyanates and/or polyols.

25. The one component reaction system as claimed in claim 18, wherein said isocyanate-reactive component B) contains at least one polyol or consists of one or more polyols, wherein the polyol more particularly has
an OH number of 100 to 400 mg KOH/g, preferably 150 to 300, and/or
an OH functionality of 1 to 4, preferably 1.5 to 3.5, more preferably 1.9 to 3.0,
and wherein the polyol is selected from the group consisting of polyether polyols, polyester polyols and polyetherester polyols.

26. The one component reaction system as claimed in claim 18, wherein is stabilizer C) is selected from the group of polyether-polydialkoxysilane copolymers, and the alkoxy groups are each selected independently from aliphatic hydrocarbyl moieties having one to ten carbon atoms, preferably from methyl, ethyl, n-propyl or i-propyl.

27. The one component reaction system as claimed in claim 18, wherein said stabilizer C) has a cloud point of not less than 40° C., measured in a 4 wt % aqueous solution of the stabilizer and incrementally raising the temperature from 20° C. starting at a heating rate of 2° C./min and ascertaining the cloud point by visually judging the onset of clouding.

28. The one component reaction system as claimed in claim 18, wherein the monomeric polyisocyanate content is less than 1 wt %.

29. The one component reaction system as claimed in claim 18, wherein the one component reaction system further comprises an acid having a pKa value of not less than 0 based on the amount of organic polyisocyanate component A).

30. The one component reaction system as claimed in claim 18, wherein the one component reaction system comprises
70 to 90 wt % of one organic polyisocyanate component A),
0.5 to 5 wt % of isocyanate-reactive component B),
0.1 to 1.0 wt % of stabilizer C),
0.1 to 1.0 wt % of catalyst D), and/or
9 to 25 wt % of auxiliary and added-substance materials and also blowing agent and co-blowing agent,
all based on the one component reaction system.

31. A method of preparing rigid PU foams, which comprises said components A) to E) of a one component reaction system as claimed in claim 18 being mixed and more particularly reacted with one another under agency of moisture.

32. A rigid foam obtained by mixing and reacting said components A) to E) of a one component reaction system as claimed in claim 18.

33. A method comprising utilizing the one component reaction system as claimed in claim 18 as a 1-K assembly foam, wherein the one component reaction system and a propellant and optionally a co-propellant are contained in a pressurized container.

34. A pressurized container comprising the one component reaction system as claimed in claim 18 and a propellant and optionally a co-propellant.
